(19) United States
(12) Patent Application Publication
(10) Pub. No.: US 2026/0318743 A1
(43) Pub. Date: Oct. 15, 2026

(54) IMAGING AND SCANNING ACCESSORIES FOR A SPECTRORADIOMETER

(71) Applicant: Novanta Corporation, Bedford, MA (US)

(72) Inventor: Matthew Falanga, Liverpool, NY (US)

(73) Assignee: Novanta Corporation, Bedford, MA (US)

(21) Appl. No.: 19/462,047

(22) Filed: Jan. 28, 2026

Related U.S. Application Data
(60) Provisional application No. 63/750,390, filed on Jan. 28, 2025.

(51) Int. Cl. G01J 3/28; G01J 3/02; G01J 3/06

(52) U.S. Cl. CPC G01J 3/2823; G01J 3/0202; G01J 3/0208; G01J 3/06; G01J 2003/064

(57) ABSTRACT

An approach for spatial and spectral measurements of display technologies using a spectroradiometer that can be selectively coupled to a camera assembly or a scanning mirror. The camera assembly is an inverted telephoto lens in some embodiments and a beamsplitter with kinematic mount that can facilitate image registration on a camera. Conoscope camera lens accessories can also be used with a beamsplitter. The scanning mirror is an XY galvanometer set.

### BACKGROUND OF THE INVENTION

### 1. Field of the Invention

The present disclosure relates to near eye metrology and, more specifically, to an approach for providing a spectrometer with a camera with conoscope lens or a scanning mirror set for augmented reality (AR) and virtual reality (VR) devices.

### 2. Description of the Related Art

In display metrology, there is a fundamental trade-off between spectral resolution and spatial resolution. A spectroradiometer can provide very detailed spectral radiance data, but only for a single spatial sample, measured through an angular aperture. Spatially scanning spectroradiometers offer a single detector alternative using fast scanning mirrors with microsecond temporal resolution in both XY directions. When the motor is actuated, a controller executes the scanning process to rapidly scan a focal point of the field of view at multiple virtual image distances (as seen through the near eye display optics), and the readings are collected and processed by the imager. Each reading corresponds to a field point in the field of view, which is collected sequentially to form spectral measurements in two dimensions.

On the other hand, a camera can provide very detailed spatial information, but is typically limited to three channels in one-to-three snapshots. In near eye display metrology applications, wide fields of view are common across a range of focal lengths based on HMD, pancake-type VR, and AR-HUD devices.

Accordingly, there is a need in the art for a spectroradiometer system that can be used in a broader range of applications by employing either a camera with lens assembly or scanning mirrors with an objective lens to test both AR and VR displays.

### BRIEF SUMMARY OF THE INVENTION

The present invention provides a spectroradiometer system that can employ either a camera system with a beamsplitter or fast scanning mirrors that provide for point-scanning of the field of view. The spectroradiometer may be selectively coupled to a camera assembly having a beamsplitter with a kinematic mount that can facilitate image registration on a camera. The spatial sensitivity of the spectroradiometer spot size can be characterized with respect to the image registration. The relative illumination distribution of the spectroradiometer may have some amount of center offset in terms of the peak sensitivity with respect to the camera image due to misalignment between the two detectors. Designing test-optics to measure the pupil at the eye point of the display under test, where the virtual image field of view can be viewed uniformly (also known as the eyebox), can be done using telecentric lenses in a conoscope apparatus. The spectroradiometer may be decoupled from the camera assembly and connected to a XY galvanometer set for spatial scanning spectroradiometry.

In one embodiment, a spectroradiometer system comprise a camera assembly having a beamsplitter for directing incoming light along a first pathway extending to a camera with a photopic filter and a second pathway and a mount that is configured to be coupled to an input of a spectrometer so that the second pathway is alignment with the input of the spectrometer. The system may further comprise a lens assembly for receiving the incoming light that is positioned in alignment with the beamsplitter. The lens assembly may include a negative crown lens with a back focal length that is substantially longer than an effective focal length. The lens assembly may include a positive crown lens. The lens assembly may includes a positive flint, negative crown lens that is spaced apart from the positive crown lens.

In another embodiment, the spectroradiometer system may be an XY galvanometer positioned to scan light received from object and direct the light along a pathway, an autofocus lens positioned in the pathway to receive the light from the XY galvanometer, and a mount aligned with the pathway to receive the light from the autofocus lens and configured to be coupled to an input of a spectrometer so that the pathway is alignment with the input of the spectrometer.

In a further embodiment, the spectroradiometer system may be a spectrometer having an input and a mount coupled to the input of the spectrometer that is accompanied by a camera assembly having a beamsplitter for directing incoming light along a first pathway that extends to a camera having a photopic filter and a second pathway that extends to the mount so that light in the second pathway is provided to the input of the spectrometer and an XY galvanometer positioned to scan light received from object and direct the light along a pathway that extends to the mount, wherein each of the camera assembly and XY galvanometer may be selectively attached to the input of the spectroradiometer. Thus, each of the camera assembly and the XY galvanometer may be selectively attached to the input of the spectroradiometer and removed from the input of the spectroradiometer and then be interchanged with the other of the camera assembly and the XY galvanometer.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a side view of a spectroradiometer coupled to a camera assembly according to the present invention.

FIG. 2 is a front view of a spectroradiometer coupled to a camera assembly according to the present invention.

FIG. 3 is a cross-sectional view of a camera assembly for selective attachment to a spectroradiometer that employs a telecentric lens according to the present invention.

FIG. 4 is a cross-sectional view of a camera assembly for selective attachment to a spectroradiometer that employs an exemplary inverse telephoto lens according to the present invention

FIG. 5 is a perspective view of a spectroradiometer coupled to an XY galvanometer set according to the present invention.

FIG. 6 is a series of graphs of MTF, distortion, and simulated output images for camera accessory measuring NEDs with 39-mm focal length (left) and 161-mm focal length (right).

FIG. 7 is a graph of the relative illumination flatness across field of view of a camera assembly according to the present invention.

FIG. 8 is a graph of micro-display object to image sensor magnification versus near eye display focal length.

### DETAILED DESCRIPTION OF THE INVENTION

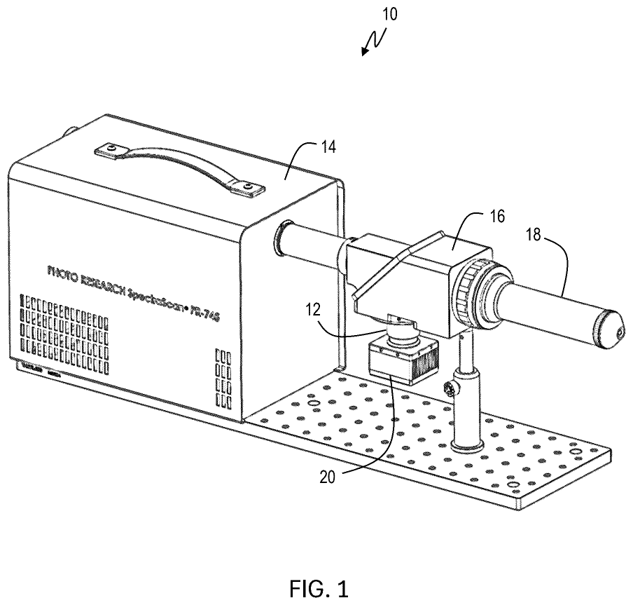

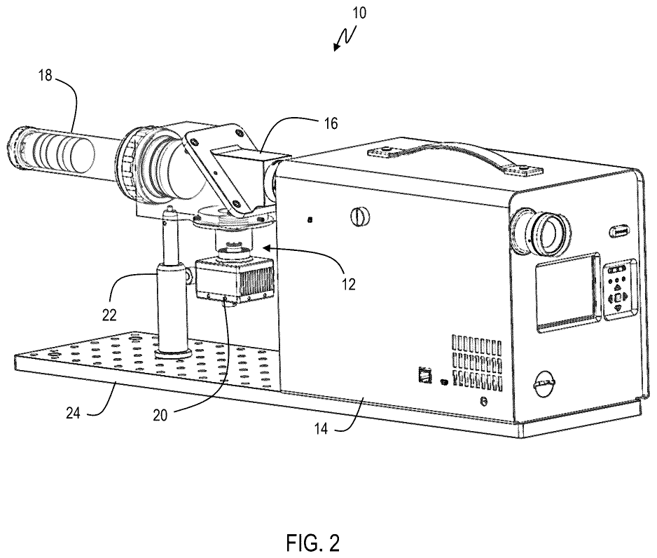

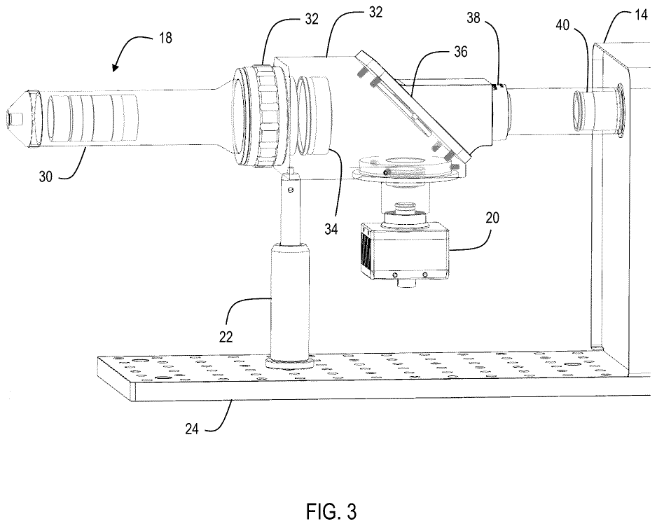

Referring to the figures, wherein like numerals refer to like parts throughout, there is seen in FIGS. 1 and 2, a spectroradiometer system 10 having a camera assembly 12 for performing near eye display metrology coupled to a spectroradiometer 14. Camera assembly 12 comprises a beamsplitter assembly 16 mounted to the entry port of spectroradiometer 14 for directing any incoming light received from a lens assembly 18 along a first pathway leading to a camera 20 and along a second pathway leading to spectroradiometer 14. The measured image may be used to calculate two-dimensional luminance, chromaticity, spectral radiance, spatial contrast, and resolution. Telephoto lens assembly 18 is supported by a pole mount 22 extending upwardly from a substrate 24 for commonly supporting camera assembly 12 and spectroradiometer 14.

Referring to FIG. 3, lens assembly 18 of camera assembly 12 is shown as a telecentric lens in a barrel 30 and is positioned along an incoming light pathway. Lens assembly 18 is coupled to a housing 32 of beamsplitter assembly 16, which encloses beamsplitter a second lens assembly 34 and a beamsplitter 36. Beamsplitter 36 directs light received from telephone lens assembly 18 along a first light pathway leading to camera 20 and a second pathway leading through a mount 38 that can be coupled to the input 40 of spectroradiometer 14. Camera 20 preferably has a photopic filter. As described herein, lens assembly 18 may comprise an inverse telephoto lens. Alternatively, lens assembly 18 may be modular, such as seen in FIG. 3, where barrel 30 can selectively comprise one of multiple AR and VR barrels of different diameters (e.g., 36 mm vs 50 mm) having the same EFL (e.g., ≈16.49 mm) that can be selectively attached to housing 32 via a barrel mount 42. In this embodiment, modular barrel 30 allows for swapping of the front optics while keeping the rear module fixed. This arrangement is particularly helpful for interfacing with near eye display (NED) systems having an entrance pupil of 5 mm, such as paraxial display models with an effective focal length (EFL) of 39 mm, and can allow for changing between a system that is diffraction-limited to one that is nearly diffraction-limited.

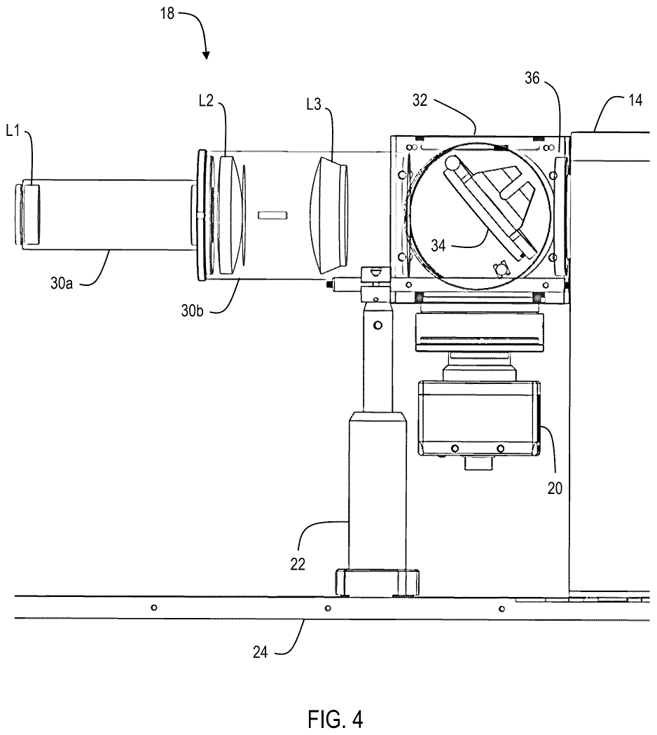

Referring to FIG. 4, lens assembly 18 of camera assembly 12 is shown as an inverse telephone lens formed with a first barrel section 30a and a second barrel section 30b coupled to housing 32 of beamsplitter 36, which is turn coupled by mount 38 to spectroradiometer 14.

When using camera assembly 12, steps should be taken to characterize the spatial sensitivity of the spectroradiometer spot size with respect to the image registration. The relative illumination distribution of the spectroradiometer may have some amount of center offset in terms of the peak sensitivity with respect to the camera image due to misalignment between the two detectors. Designing test-optics to measure the pupil at the eye point of the display under test, where the virtual image field of view can be viewed uniformly (also known as the eyebox), can be done using telecentric lenses in a conoscope apparatus.

Telephoto lens assembly 18 is preferably releasably coupled to beamsplitter assembly 16 so that different configuration lens assemblies 18 may be used. For example, bolted shoulder screws may be used to connect telephoto lens assembly 18 to beamsplitter assembly 16. An acceptable telephoto lens assembly 18 may have a barrel with an outer diameter of 36 mm (OD) for AR test procedures as compared to 50 mm for the barrel of an assembly 18 used for VR test procedures. Since the same camera 20 may be used in both AR and VR test cases and because the focal length remains the same, the 24° region underfills the sensor. The image circle diameter is 7.3 mm for a 24° full field of view (FFOV) in the AR test configuration and 10.1 mm at 32° FFOV in the VR test configuration. This region maintains >90% relative illumination. As field is increased further the relative illumination drops due to vignetting on the barrel. The AR configuration with vignetting can measure up to 30° FFOV, while the VR configuration with vignetting up to 40° FFOV. Despite broader coverage, the lenses maintain near diffraction-limited performance for a 5-mm pupil.

In testing of both configurations, both options achieve nearly diffraction-limited performance across the field of view for a 5-mm pupil. The extended optical MTF is >50% contrast up to 100 cycles/degree, indicating excellent image quality. When combined with the sensor's sinc-based MTF response, the system MTF maintains 70 cycles/degree. This confirms that the optics and sampling together support high-fidelity measurement of near-eye displays.

The instantaneous angular resolution per pixel is given by the equation:

$${tan}^{- 1} ( \frac{pixel size}{focal length} ) .$$

Given this value as 0.01199° per pixel (83.4 PPD), the on-axis cut-off frequency would be approximately 42 cycles/degree. While useful for optical design, the PPD and Nyquist calculations are derived from the image circle and pixel count to reflect actual system performance. For the 24° FFOV, approximately 2116 pixels span the image circle, yielding a PPD of 88 and a Nyquist frequency of 44 cycles/degree. In either case, the values are nearly two-fold the human eye's Nyquist frequency (~22.3 cycles/degree), further confirming the system's capability for high-fidelity measurement. The Nyquist frequency of the cone mosaic is 22.3 cycles per degree, which corresponds to the spatial frequency at which aliasing would begin if the eye were a linear sampling system. The measuring system in this report achieves ~2× that resolution, which is good. Further improvement is achievable with shorter pixel pitch (e.g., 2.4 μm) sensors.

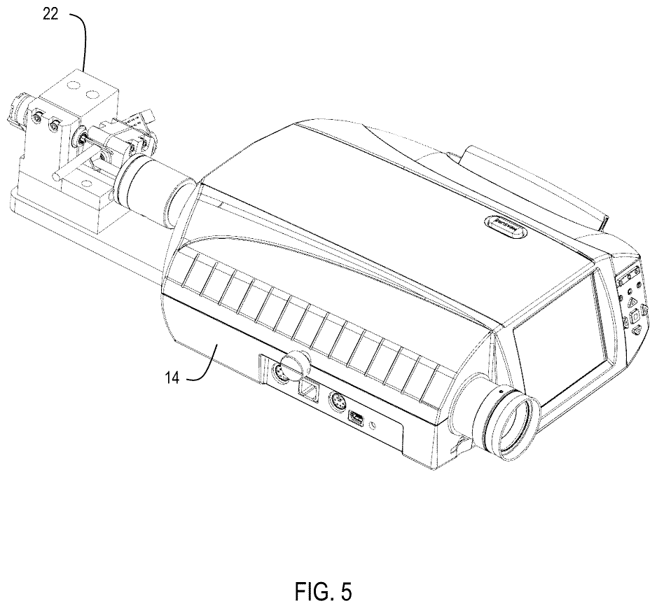

Referring to FIG. 5, camera assembly 12 may be disconnected from spectroradiometer 14 and interchanged with an XY galvanometer set 22 for spatial scanning spectroradiometry. These accessories each have their own strengths and caveats. If a spectral measurement is needed per microdisplay pixel, then only the scanning mirror is suitable. If speed is of the utmost importance, then the camera is suitable. This embodiment uses the pair of motorized scanning mirrors of XY galvanometer set 22 with an autofocus lens and spectroradiometer 14 to provide display measurements across +/−40° field of view. Each focal point on the display is scanned with complete spectral data for a given integration time. Since multiple exposures are not desirable for high throughput production workflows, this embodiment was shown to be more appropriate for analog photometers. Galvanometer-driven mirror pairs of XY galvanometer set 22 are capable of raster scanning at kHz rates, enabling high-throughput imaging or processing when combined with an analog photometer for continuous real-time measurement of luminance. When the motor of XY galvanometer set 22 is actuated, a controller executes the scanning process to rapidly scan a focal point of the field of view at multiple virtual image distances (as seen through the near eye display optics), and the readings are collected and processed by spectroradiometer 14. Each reading corresponds to a field point in the field of view, which is collected sequentially to form spectral measurements in two dimensions.

Thus, in an embodiment, the system may involve selecting one of camera assembly 12 and XY galvanometer set 22 and then attaching the selected device to the input of spectroradiometer 14 for certain testing operations. That device may then be disconnected from the input of spectroradiometer 14 and the other of camera assembly 12 and XY galvanometer set 22 connected to the input of spectroradiometer 14 in place of the first device to perform different testing operations. In practice, a kit may be provided that includes spectroradiometer 14 and both camera assembly 12 and XY galvanometer set 22, or spectroradiometer 14 may be offered with just one of camera assembly 12 and XY galvanometer set 22 with the user having the ability to add the other of camera assembly 12 and XY galvanometer set 22 at a later date. Along these lines, one or both of camera assembly 12 and XY galvanometer set 22 may be offered as a retrofit to existing spectroradiometers.

Test-optics were designed to measure near eye displays with a wide range of field of view and focal length. Table 2 below shows some example NEDs:

TABLE 2
Example Near Eye Displays

| Model | Type | D-FOV |
|---|---|---|
| Google Glass | AR | 15 |
| Microsoft HoloLens Gen II | AR | 43 |
| Magic Leap Gen II | AR | 45 |
| Meta Ray-Ban Glass | AR | 88 |
| Oculus Rift | VR | 88 |
| Samsung Gear | VR | 101 |
| Pico 4 | VR | 104 |
| Meta Quest | VR | 108 |
| HTC Vive | VR | 108 |
| Oculus Rift | VR | 110 |
| Picmax 8K | VR | 160 |
| StarVR | VR | 178 |

The present invention allows for a trade-off in terms of etendue when designing the test-optics for measuring a near eye display with a camera accessory. If the instrument is swapped between different systems, e.g., from a pancake-type VR lens to an AR-HUD for a windshield, the size of the image will be reduced. XY galvanometer set 22 can be matched to the pupil of near eye displays regardless of focal length. The present invention includes a simulated ray trace model to characterize image quality for different test cases when using XY galvanometer set 22.

The field of view for AR-HUD is typically +/−11°, whereas the field of view for HMD is on the order of +/−20°, and pancake +/−35°. To demonstrate the interaction between a near eye display and spectroradiometer with image accessories, a model was developed in Zemax OpticStudio (ZEMAX LLC, USA). First, a conoscope lens was designed that can resolve up to +/−25° FOV with diffraction-limited performance for a 2-mm pupil. The measurement model is shown as a function of near eye display focal length from 39 mm to 161 mm. To be compatible with near eye displays, the measurement accepts pupils of 5 mm. The final optical design method examines the utility of the XY Galvanometer Set in a separate Zemax OpticStudio model with an upper limit of +/−40° FOV.

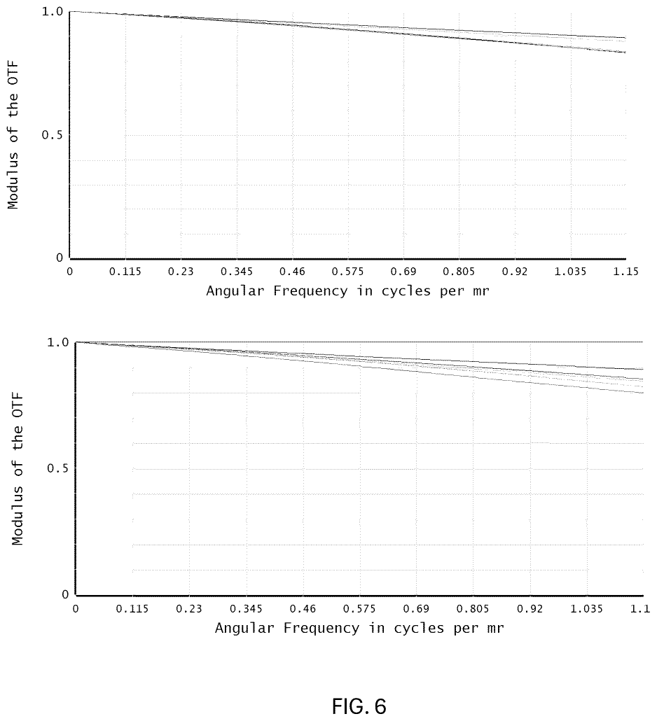

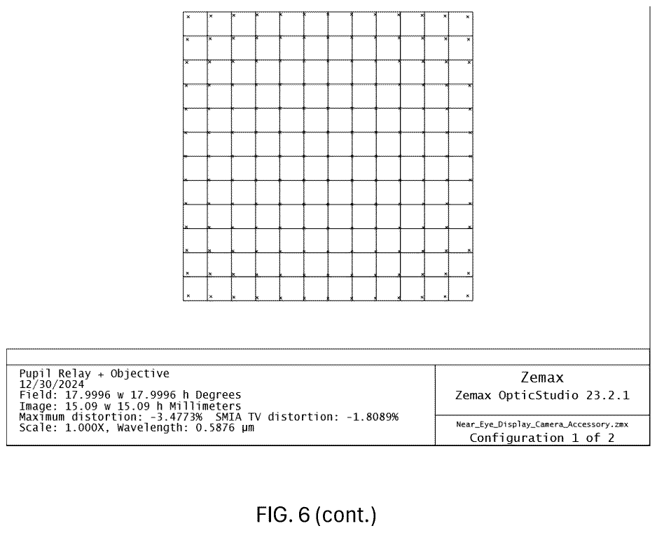

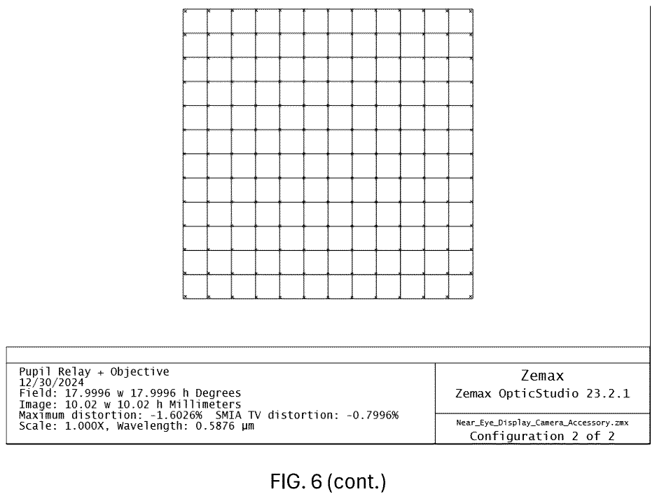

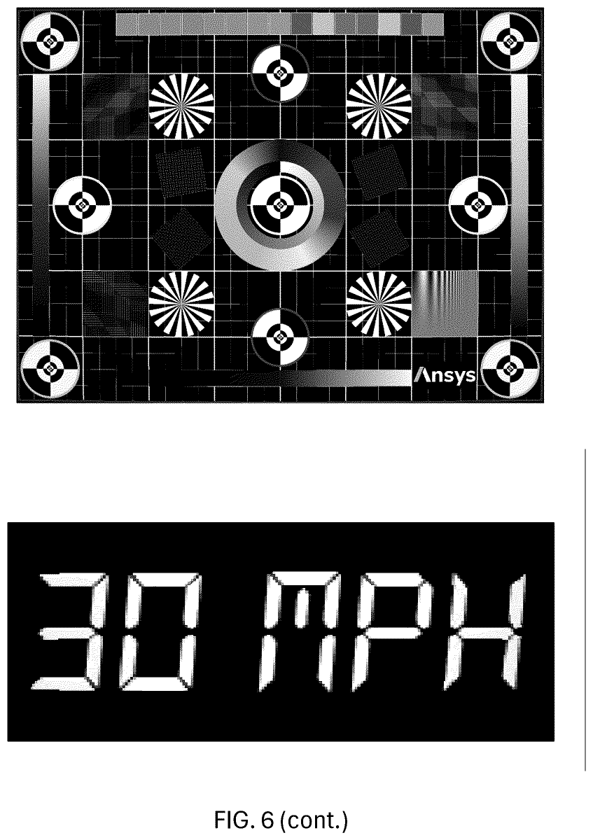

Diffraction-limited performance has been achieved across the field of view for a pupil diameter of 5 mm. This was the result by using a pupil relay before the camera objective. The performance of this arrangement is given by the image quality criteria in FIG. 6. Image quality above 80% contrast at 20 cy/deg is maintained for 40 deg with camera and 80 deg with scanning mirror. Diffraction-limited performance is maintained on-axis and off-axis up to +/−20° for the 39-mm focal length (left) and +/−14° for 161-mm focal length (right). Distortion is held below 3.5% at +/−20°. Diffraction-limited image quality is thus available for fields of view up to 40° D-FOV, which is more than twice as wide as conventional systems.

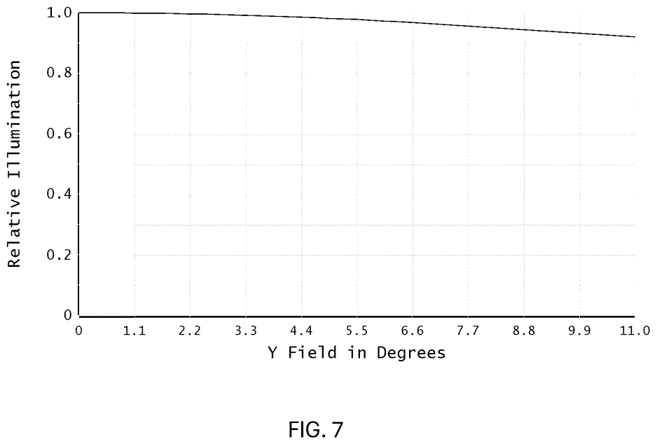

The spatial sensitivity and sampling across the radially symmetric FOV does not depend on focal length and is shown below (95% roll-off at edge of field) in FIG. 7.

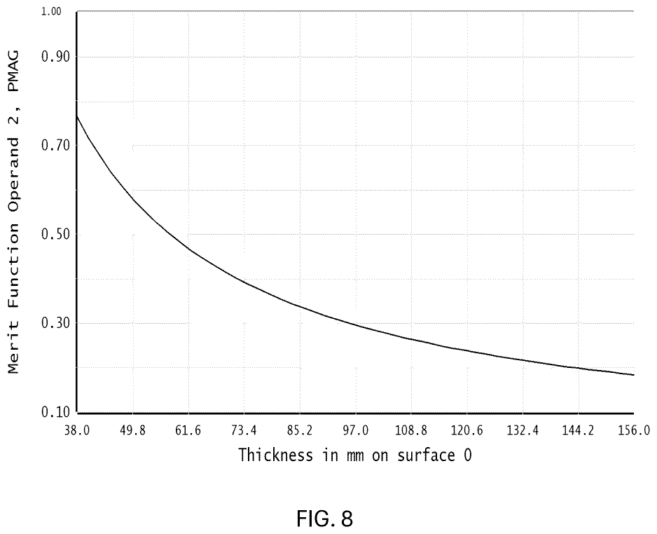

While optical image quality remains comparable, the sampled resolution by pixels is reduced for the smaller image. FIG. 8 examines this balancing measure related to a four-fold change in focal length.

The scanning mirror accessory is notably unaffected by swapping devices with different focal length. To highlight this point with a practical example from the Zemax Knowledgebase, the field of view of an AR-HUD is scanned with 5-mm pupil, as seen in FIG. 10.

In exchange for the pupil shift, the off-axis rays that were once problematic are simplified to an on-axis optimization for the objective, as seen in FIG. 11. Diffraction-limited performance is obtainable with the size of the mirror and its range of motion as the only constraints for pupil diameter and field of view, respectively.

The present invention thus provides for a camera assembly and XY galvanometer set that are viable with existing spectroradiometer platforms. A limitation is observed for camera measurements when the focal length of the near eye display device changes and the etendue reduces. This is not the case for the XY scanning mirror set, although a pupil shift is observed. Indeed, this shift has been compensated for in fluorescence microscopy literature where a stationary pupil is made possibly by using third scanning mirror. Three mirrors (rather than two) ensure that the pupils of the XY galvanometer set are coincident. The first two mirrors are moved in the same plane so that the beam rotates about a pupil centered on the third mirror which rotates in the orthogonal direction. In this manner the pupil remains substantially stationary over a large scan range. The virtual conjugate arrangement of these mirrors results in a total scan range of 32.2°, compared to +/−40° for the same XY galvanometer set.

Both accessories can thus serve a variety of NED applications. The caveats identified for the camera include diffraction-limited image quality across the FOV and variable magnification when swapping NEDs of different focal length. While diffraction-limited image quality is improved to 40° D-FOV for the camera accessory, the scanning mirror maintains such for 80 D-FOV. Magnification is also invariant.

What is claimed is:

1. A spectroradiometer system, comprising:
a camera assembly having a beamsplitter for directing incoming light along a first pathway extending to a camera with a photopic filter and a second pathway; and
a mount that is configured to be coupled to an input of a spectrometer so that the second pathway is alignment with the input of the spectrometer.

2. The spectroradiometer system of claim 1, further comprising a lens assembly that is positioned in alignment with the incoming light and the beamsplitter.

3. The spectroradiometer system of claim 2, wherein the lens assembly includes a negative crown L1 with a back focal length that is substantially longer than an effective focal length.

4. The spectroradiometer system of claim 3, wherein the lens assembly includes a positive crown lens.

5. The spectroradiometer system of claim 4, wherein the lens assembly includes a positive flint, negative crown lens that is spaced apart from the positive crown lens.

6. The spectroradiometer system of claim 2, wherein the lens assembly comprises an inverse telephoto lens.

7. The spectroradiometer system of claim 2, wherein the lens assembly is modular lens.

8. The spectroradiometer system of claim 7, wherein the modular lens has a front barrel that is removeable.

9. The spectroradiometer system of claim 8, wherein the front barrel may be selected from the group consisting of an augmented reality barrel and a virtual reality barrel.

10. The spectroradiometer system of claim 9, wherein the augmented reality barrel and the virtual reality barrel have different diameters.

11. The spectroradiometer system of claim 10, wherein the augmented reality barrel and the virtual reality barrel have the same effective focal length.

12. A spectroradiometer system, comprising:
an XY galvanometer positioned to scan light received from object and direct any incoming light along a pathway;
an autofocus lens positioned in the pathway to receive the incoming light from the XY galvanometer; and
a mount aligned with the pathway to receive the incoming light from the autofocus lens and configured to be coupled to an input of a spectrometer so that the pathway is alignment with the input of the spectrometer.

13. A spectroradiometer system, comprising:
a spectroradiometer having an input;
a mount coupled to the input of the spectrometer;
a camera assembly having a beamsplitter for directing incoming light along a first pathway that extends to a camera having a photopic filter and a second pathway that extends to the mount so that light in the second pathway is provided to the input of the spectrometer;
an XY galvanometer positioned to scan light received from object and direct the light along a pathway that extends to the mount;
wherein each of the camera assembly and the XY galvanometer may be selectively attached to the input of the spectroradiometer and removed from the input of the spectroradiometer and interchanged with the other of the camera assembly and the XY galvanometer.

14. The spectroradiometer system of claim 13, further comprising a lens assembly that is positioned in alignment with the incoming light and the beamsplitter.

15. The spectroradiometer system of claim 14, wherein the lens assembly comprises an inverse telephoto lens.

16. The spectroradiometer system of claim 14, wherein the lens assembly has a front barrel that is removeable.

17. The spectroradiometer system of claim 16, wherein the front barrel may be selected from the group consisting of an augmented reality barrel and a virtual reality barrel.

18. The spectroradiometer system of claim 17, wherein the augmented reality barrel and the virtual reality barrel have different diameters.

19. The spectroradiometer system of claim 18, wherein the augmented reality barrel and the virtual reality barrel have the same effective focal length.
